(19) United States
(12) Patent Application Publication
(10) Pub. No.: US 2016/0256947 A1
(43) Pub. Date: Sep. 8, 2016

(54) ENHANCED PDC CUTTER POCKET SURFACE GEOMETRY TO IMPROVE ATTACHMENT

(71) Applicant: HALLIBURTON ENERGY SERVICES, INC., Houston, TX (US)

(72) Inventor: Robert W. Arfele, Magnolia, TX (US)

(21) Appl. No.: 15/029,021

(22) PCT Filed: Nov. 13, 2013
(86) PCT No.: PCT/US2013/069809

§ 371 Date: Apr. 13, 2016

(51) Int. Cl. B23K 1/00; E21B 10/56

(52) U.S. Cl. CPC B23K 1/0008; E21B 10/56; E21B 10/42

(57) ABSTRACT

The present disclosure relates to an industrial device, such as a drill bit including a PCD element located in a recess of the industrial device. The industrial device may also include a plurality of spacers distributed across a surface of the recess and a brazing material located along at least a portion of an interface between the PCD element and the recess.

### TECHNICAL FIELD

The current disclosure relates to polycrystalline diamond (PCD) elements and industrial devices, such as earth-boring drill bits having a spacer in a pocket where an attachment joint is also formed.

### BACKGROUND

Components of various industrial devices are often subjected to extreme conditions, such as high-temperatures and high-impact contact with hard and/or abrasive surfaces. For example, extreme temperatures and pressures are commonly encountered during earth drilling for oil extraction or mining purposes. Diamond, with its unsurpassed mechanical properties, can be the most effective material when properly used in a cutting element or abrasion-resistant contact element for use in earth drilling. Diamond is exceptionally hard, conducts heat away from the point of contact with the abrasive surface, and may provide other benefits in such conditions.

Diamond in a polycrystalline form has added toughness as compared to single-crystal diamond due to the random distribution of the diamond crystals, which avoids the particular planes of cleavage found in single-crystal diamond. Therefore, polycrystalline diamond (PCD) is frequently the preferred form of diamond in many drilling applications. A drill bit cutting element that utilizes PCD is commonly referred to as a polycrystalline diamond cutter (PDC). Accordingly, a drill bit incorporating PCD cutting elements may be referred to as a PDC bit.

PCD elements can be manufactured in a press by subjecting small grains of diamond and other starting materials to ultrahigh pressure and temperature conditions. One PCD manufacturing process involves forming polycrystalline diamond directly onto a substrate, such as a tungsten carbide substrate. The process involves placing a substrate, along with loose diamond grains mixed with a catalyst binder, into a container of a press, and subjecting the contents of the press to a high-temperature, high-pressure (HTHP) press cycle. The high temperature and pressure cause the small diamond grains to form into an integral PCD intimately bonded to the substrate.

Once formed, the PCD element can then be attached to a drill bit via the substrate. Due to differences in materials properties such as wettability, a substrate is typically easier to bond to another surface than diamond is when using certain methods. For example, a PCD element can be attached at its substrate to the drill bit via soldering, brazing, or other adhesion method, whereas PCD without a substrate could not be easily bonded to a drill bit with sufficient strength to withstand the conditions of drilling. Soldering and brazing may be performed at relatively low temperatures at which the PCD portion of the element remains stable, so that the PCD portion is not adversely affected by the process of joining to the bit.

### BRIEF DESCRIPTION OF THE DRAWINGS

A more complete understanding of the present embodiments and advantages thereof may be acquired by referring to the following description taken in conjunction with the accompanying drawings, which show particular embodiments of the current disclosure, in which like numbers refer to similar components, and in which:

FIG. 1 is a side view of a spacer for fabricating a drill bit;

FIG. 2A is a side view of another spacer for fabricating a drill bit;

FIG. 2B is a cross-section view of the spacer of FIG. 2A;

FIG. 3 is a cross-section view of a drill bit containing a PCD element;

FIG. 4 is a cut-away cross-section view of drill bit containing a helical groove; and

FIG. 5 is an industrial device incorporating the drill bit and the PCD element.

### DETAILED DESCRIPTION

The current disclosure relates to a drill bit that may be coupled with a PCD element, such as a cutter for use during drill bit operation. The PCD element may be located in a recess or pocket of the drill bit. Merely placing the PCD element in the recess or pocket is not normally sufficient to retain the PCD element in the bit during operation. Accordingly, a brazing material, adhesive, or other fixative material may be placed between the PCD element and the recess or pocket. It is often helpful for such a material to have a particular thickness between the PCD element and the recess or pocket. Accordingly, the present disclosure includes constructs and methods, such as the use of spacers, to establish and maintain an optimal or uniform distance between the PCD element and the recess or pocket, so that a brazing material or other material placed between the PCD element and the recess or pocket will have an optimal or uniform thickness.

More particularly, the present disclosure relates to a drill bit having spacers as well as a drill bit having a coupled PCD element and a spacer. The spacer may be configured to optimize or make uniform the distance between the PCD element and drill bit. For example, the PCD element and drill bit may be coupled through an adhesion process such as soldering, brazing, or the use of an adhesive. In order for an optimal or uniform adhesion joint to form, an optimal uniform gap between the PCD element and drill bit may be desirable. The gap may vary depending on, for example, the materials from which the drill bit is formed, the brazing material, the brazing method, the material from which any substrate of the PCD element may be formed, the adhesive used, etc.

The current disclosure further relates to a PCD element coupled to a drill bit using a coupling method that takes advantage of a spacer present in the drill bit. The drill bit and methods described herein may additionally facilitate the PCD element optimally coupling with the drill bit at the braze joint.

The spacer may be designed to institute an optimal or uniform distance, such as an optical base gap between the PCD element and a recess or pocket in the drill bit along at least a portion of the interface between the PCD element and the recess. It may be designed such that the spacer may maintain the optimal or uniform distance between the PCD element and the recess along at least a portion of the interface between the PCD element and the drill bit. The spacer may be designed such that it is sufficiently wettable by the braze material. For example, a spacer may be constituted of a material that allows the braze material or other adhesive to adhere to the spacer in a manner sufficient to facilitate the adhesion process.

The drill bit may further contain an optimal or uniform distance, such as an optimal base gaping material located along at least a portion of the interface between the PCD element and the recess. In some embodiments, a brazing material or other adhesive may be located along substantially all of the interface. In other embodiments, brazing material or other adhesive may be located primarily at the spacer. In the same or alternative embodiments, it may be located primarily along a portion of the interface between the PCD element and the recess that is not the spacer.

The brazing material may be provided in any form prior to the brazing process, but in particular embodiments it may be in the form of a thin foil or a wire. It may be designed such that the foil has a uniform thickness between the substrate and the recess along at least a portion of the interface. This uniform thickness of the foil may facilitate formation of an optimal or uniform distance between the PCD element and the recess during the brazing process. It may be designed such that contact area between the substrate of the PCD element and the recess along at least a portion of the interface is increased so that the strength of the braze joint is increased. The brazing material may be composed of any materials able to form a braze joint between the PCD element and the pocket. In particular embodiments it may include manganese (Mn), aluminum (Al), phosphorus (P), silicon (Si), or zinc (Zn) alloyed with nickel (Ni), copper (Cu) or silver (Ag).

The PCD element may be located in the recess such that substantially only the substrate portion of the PCD element lies along the interface, with substantially none of the PCD portion located along the interface. Such an arrangement may protect the PCD from materials and temperatures used in the brazing process. Such an arrangement may also make the maximum area of PCD available for cutting. In some embodiments, substantially all of the substrate may be located within the recess to provide maximum mechanical stability or attachment of the PCD element to the drill bit.

The PCD element may be brazed into a drill bit by placing the PCD element and a brazing material into a recess in the bit, such that the spacer in the recess institutes an optimal or uniform distance between the PCD element and the drill bit, then heating the brazing material to a temperature sufficient for a braze joint to form between the PCD element and the recess along at least a portion of the interface. Typically the brazing material may be heated to at least its melting point. The brazing material may be placed in the recess prior to placement of the PCD element. Additionally, because the brazing material may be displaced from its original position during the brazing process, for example by melting or movement of the PCD element, it need not cover the entire area to be brazed prior to the brazing process.

The PCD element may also be removed from the recess by re-heating the brazing material, typically to at least its melting point, then physically dislocating the PCD element. A new PCD element may then be inserted into the recess and attached via a braze joint. The spaces may remain in tact through at least one replacement of the PCD element.

In some embodiments, the PCD element may be rotated in the recess by heating the brazing material to a temperature sufficient to allow movement of the PCD element. This ability to rotate a PCD element may increase overall drill bit or PCD element life by allowing worn areas of the PCD element to moved and replaced with less worn areas without switching to an entirely new PCD element.

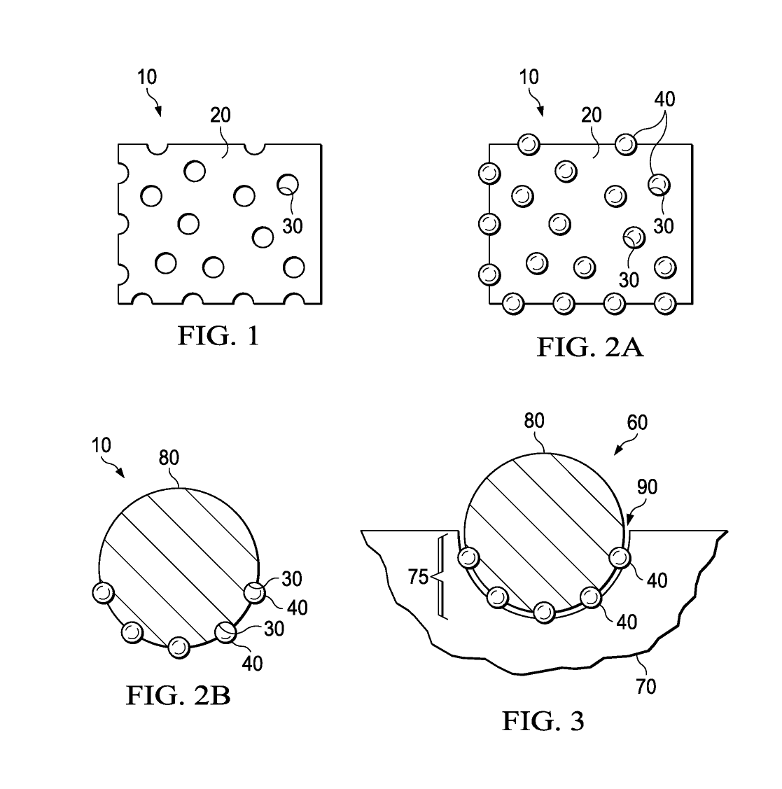

The spacer may be of any appropriate size, shape, or material designed to institute a distance, such as an optical or uniform distance, including, but not limited to an optical or uniform braze gap between the PCD element and the recess of the drill bit optimal for a braze joint to form between the PCD element and the drill bit. Further, the spacer may be integrated with, or separate from, the drill bit. In some embodiments, the spacer may be manufactured as part of the drill bit body, as described in more detail below with reference to FIG. 1. In the same or alternative embodiments, the spacer may be a separate body from the drill bit body, with the two combined during fabrication of the drill bit, as described in more detail below with reference to FIGS. 2A-2B.

The current disclosure further relates to methods of fabricating a drill bit in accordance with the spacer described above. Fabricating the drill bit may include creating a displacement insert for use in fabrication. The displacement insert generally corresponds to the geometry of the PCD element. The displacement insert may be formed from any appropriate material capable of being machined or consolidated in a molding operation. For example, the displacement insert may be formed from graphite, or from a sand or ceramic material.

One embodiment of the displacement insert is shown in FIG. 1. Displacement insert 10 includes insert body 20 containing a plurality of divots 30. Divots 30 may be of any appropriate shape to facilitate the formation of spacers in the recess of the drill bit during fabrication. For example, divots 30 may be hemispherical holes drilled to a specific depth. The depth corresponds to the height of the desired spacer. For example, divots 30 may have a depth on the order of one two thousandths of an inch.

In other embodiments, divots 30 may have other shapes. For example, divots 30 may be a conical shape. The use of divot 30 in a conical shape may result in a conically-shaped spacer. Such a spacer may allow a substrate supporting the PCD element to rest on the point of the cone. In such embodiments, more surface area of the bit body element material may be exposed to the braze material. As another example, divots 30 may be a conical shape. In such a configuration, divots 30 may be drilled using a standard-shaped machine drill, resulting in a cylindrical divot 30.

Displacement insert 10 may be used in the fabrication of the drill bit. For example, displacement insert 10 may be positioned in a graphite mold in designated pockets pre-machined to locate positions for one or more PCD element(s) on the finished drill bit element. Displacement insert 10 may be secured in place with, for example, an adhesive holding the displacement insert from movement during the infiltration process. Once cooled, the body of the drill bit may be extracted from the mold and displacement insert 10 removed. The result will be a pocket or recess formed in the body of the drill bit into which one or more PCD element(s) may be coupled. The surface of the recess will exhibit protrusions corresponding to the size and shape of divots 30. These protrusions will hold a portion of the PCD element a distance apart from the body of the drill bit element, controlling the braze gap.

In the embodiment shown in FIG. 2A-2B, displacement insert 10 includes a plurality of spacers 40 embedded within divots 30 of insert body 20. As detailed above, the function of spacers 40 is to create protrusions on the surface of the recess on the body of the brill bit element in order to optimize or make uniform the braze gap between the drill bit and the PCD element.

In the embodiment shown in FIG. 2A, spacers 40 may be of any appropriate size and shape, as detailed above with reference to FIG. 1. Further, the plurality of spacers 40 may be spatially organized in such a manner as to evenly cover the surface of a recess within the drill bit while still allowing sufficient surface area of the recess to be available to a brazing material or other adhesive to form an acceptable joint. For example, spacers 40 may be spherical spacers embedded within displacement body 20. Spacers 40 may be of any appropriate material for use in the fabrication and brazing processes. For example, spacers 40 may be made of nickel. Spacers 40 may be of a size chosen for a particular distance between the PCD element and the recess of the drill bit. For example, spacers 40 may be on the order of three to four thousandths of an inch.

In the embodiment shown in FIG. 2B, spacers 40 constitute protrusions on at least a portion of insert body 20. As described in more detail above and below with reference to FIG. 3, displacement insert 10 may be used in the fabrication of the drill bit. By using spacers 40 as part of displacement insert 10, spacers 40 would be left behind in the body of the drill bit during fabrication. Such a process would result in the spacers being constituted of a material potentially different from the material used in the body of the drill bit.

In some embodiments, spacers 40 may be of a different shape than divots 30. For example, spacers 40 may be a wire mesh appropriately affixed to displacement insert 10. Such a wire mesh could then be used to provide the appropriate braze gap between the drill bit and the PCD element.

FIG. 3 shows a cross section of drill bit 60 fabricated using displacement insert 10 described in more detail above with reference to FIGS. 1-2. Drill bit 60 includes drill bit body 70 including recess 75. Drill bit body 70 is coupled to PCD element 80 via a brazing material applied through braze gap 90. In some embodiments, spacers 40 hold PCD element 80 a set distance away from drill bit body 70. This distance, denoted as braze gap 90, may then be used to facilitate the introduction of the brazing material during the brazing process. The distance may be uniform or optimal, resulting in a uniform of optimal base gap.

In some embodiments, the brazing material may be an alloy available as a solid wire, cream, powder, or other substance. The brazing material may be applied to braze gap 90 in order to join PCD element 80 and drill bit 60.

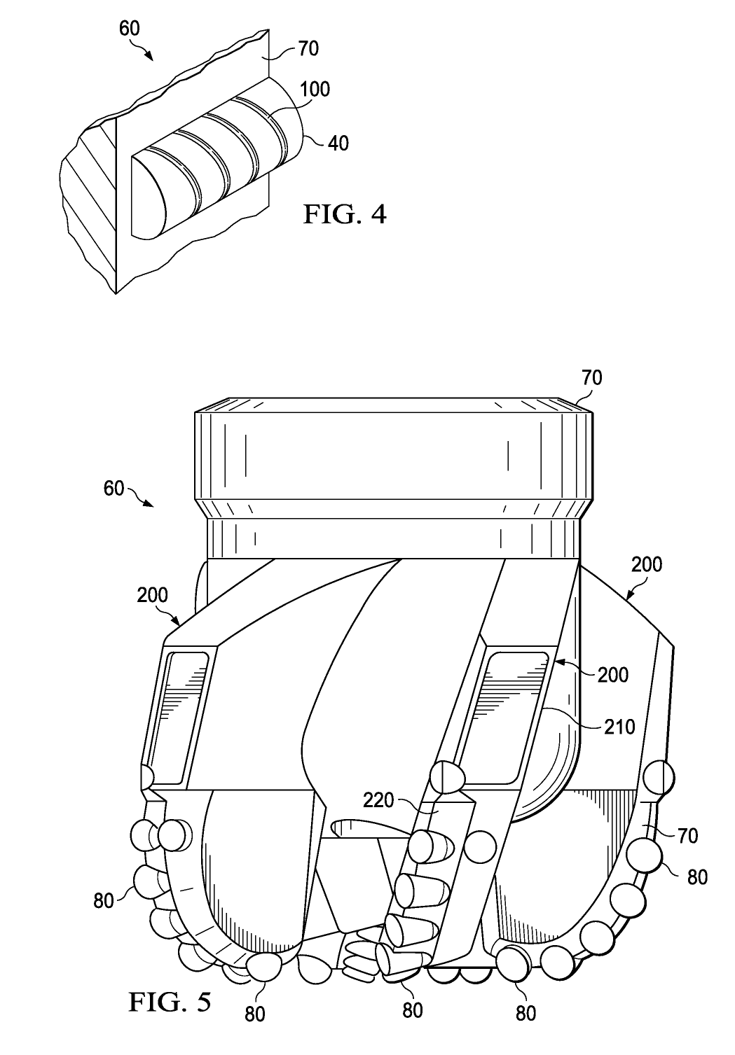

Drill bit body 20 may accommodate the brazing material in a helical groove 100 between spaces 40. A particular form of the brazing material may come in wire form. As illustrated in FIG. 4, drill bit body 70 may include formations 100 designed to accommodate brazing material 110. In the specific embodiment illustrated in FIG. 4, brazing material 110 is used in a wire form. Consequently, formations 100 in drill bit body 70 are of a shape to accommodate the wire form of brazing material 110. For example, formations 100 are a helical groove made within drill bit element body 70. In such a manner, brazing material 110 may be present within braze gap 90 prior to the addition of PCD element 80. Appropriate portions of drill bit element 60 may then be heated to a temperature appropriate to melt the brazing material and form the braze joint.

Drill bit 60 may be an earth-boring drill bit, such as a fixed cutter drill bit. FIG. 5 illustrates a fixed cutter drill bit 60 containing a plurality of PCD elements 80 coupled to drill bit body 70. Fixed cutter drill bit 300 may include bit body 70 with a plurality of blades 200 extending therefrom. Bit body 70 may be formed from steel, a matrix material, or other suitable bit body material. Bit body 70 maybe formed to have desired wear and erosion properties. PCD elements may be mounted on the bit using methods of this disclosure or using other methods.

For the embodiment shown in FIG. 5, fixed cutter drill bit 60 may have five (5) blades 200. For some applications the number of blades disposed on a fixed cutter drill bit incorporating teachings of the present disclosure may vary between four (4) and eight (8) blades or more. Respective junk slots 210 may be formed between adjacent blades 200. The number, size and configurations of blades 200 and junk slots 210 may be selected to optimize flow of drilling fluid, formation cutting and downhole debris from the bottom of a wellbore to an associated well surface. Drilling action associated with drill bit 60 may occur as bit body 70 is rotated relative to the bottom (not expressly shown) of a wellbore in response to rotation of an associated drill string (not expressly shown). At least some cutters 80 disposed on associated blades 200 may contact adjacent portions of a downhole formation (not expressly shown) drilling. These cutters 80 may be oriented such that the PCD contacts the formation. The inside diameter of an associated wellbore may be generally defined by a combined outside diameter or gage diameter determined at least in part by respective gage portions 200 of blades 200.

Bit body 70 may be formed from various steel alloys or other materials having desired strength, toughness and machinability.

Although only exemplary embodiments of the invention are specifically described above, it will be appreciated that modifications and variations of these examples are possible without departing from the spirit and intended scope of the invention. For instance, the proper placement and orientation of PCD elements on other industrial devices may be determined by reference to the drill bit example. Additionally, the spacers and methods of the present disclosure may be adapted to other forms of attachment between a PCD element and a recess, such as soldering.

1. An earth-boring drill bit comprising:
a polycrystalline diamond (PCD) element located in a recess of a bit body;
a plurality of spacers distributed across a surface of the recess; and
an adhesive located along at least a portion of an interface between the PCD element and the recess in an adhesive gap.

2. The bit of claim 1, wherein the plurality of spacers are substantially hemispherical.

3. The bit of claim 1, wherein the plurality of spacers are substantially conical.

4. The bit of claim 1, wherein the adhesive gap is defined substantially by the size of the spacers.

5. The bit of claim 1, wherein the plurality of spacers are fabricated as an integral part of the bit body.

6. The bit of claim 1, wherein the plurality of spacers are of a different material than the bit body.

7. The bit of claim 1, wherein the adhesive is located in a helical groove defined by the plurality of spaces.

8. The bit of claim 8, wherein the adhesive gap is uniform.

9. The bit of claim 9, wherein the adhesive gap is optimal for the PCD element, adhesive, and bit body.

10. The bit of claim 7, wherein the adhesive is in the form of a wire.

11. The bit of claim 1, wherein the adhesive is a brazing material comprising manganese (Mn), aluminum (Al), phosphorus (P), silicon (Si), or zinc (Zn) alloyed with nickel (Ni), copper (Cu) or silver (Ag).

12. A displacement insert for use in fabricating an earth-boring drill bit, the displacement insert comprising:
an insert body of a shape corresponding to a recess in the earth-boring drill bit; and
a plurality of divots formed in the insert body, the divots shaped to correspond to a plurality of spacers distributed across a surface of the recess, the spacers substantially defining an adhesive gap between the recess and a polycrystalline diamond (PCD) element located in the recess.

13. The displacement insert of claim 12, wherein the plurality of divots are substantially hemispherical.

14. The displacement insert of claim 12, wherein the plurality of divots are substantially conical.

15. The displacement insert of claim 12, wherein the displacement insert comprises graphite.

16. The displacement insert of claim 12, wherein the displacement insert comprises a ceramic.

17. The displacement insert of claim 12, further comprising a plurality of spacers coupled to the displacement insert, wherein one spacer is coupled to the displacement at one divot.

18. The displacement insert of claim 17, wherein the plurality of spacers comprise nickel (Ni).

19. The displacement insert of claim 17, wherein the spacers are removably coupled to the displacement insert.

20. The displacement insert of claim 19, wherein the spacers are removably coupled to the displacement insert such that the spacers may remain in the earth-boring drill bit after fabrication.
